(19) United States
(12) Patent Application Publication
(10) Pub. No.: US 2009/0161279 A1
(43) Pub. Date: Jun. 25, 2009

(54) OUTPUT CIRCUITS

(75) Inventor: Jung-Yen KUO, Yunlin County (TW)

Correspondence Address: Muncy, Geissler, Olds & Lowe, PLLC, P.O. BOX 1364, FAIRFAX, VA, 22038-1364, US

(73) Assignee: PRINCETON TECHNOLOGY CORPORATION

(21) Appl. No.: 12/041,331

(22) Filed: Mar. 3, 2008

(30) Foreign Application Priority Data
Dec. 21, 2007 (TW) 096221829

(51) Int. Cl. H02H 9/02

(52) U.S. Cl. 361/100

(57) ABSTRACT

An output circuit preventing damage by electrostatic discharge current is provided, comprising a voltage source, a power-clamp ESD circuit, a PMOS transistor, an NMOS transistor, and a diode. The voltage source provides a voltage. The power-clamp ESD circuit is coupled to the voltage source and directs the electrostatic current to flow in a current direction. The PMOS transistor is coupled to the voltage source. The NMOS transistor is coupled to the PMOS transistor. The diode is coupled to the voltage source. The output unit is coupled to the diode and the PMOS transistor.

### BACKGROUND OF THE INVENTION

1. Field of the Invention

The invention relates to an output circuit, and more particularly to an output circuit with a power-clamp electrostatic discharge (ESD) circuit.

2. Description of the Related Art

For general circuit design, to avoid damaging a circuit by static electricity of human bodies or environment, a circuit set is required in the circuit for preventing the entire circuit from damage and reduction of operating lifespan.

The circuit set is usually referred to an electrostatic discharge (ESD) prevention circuit. For a conventional ESD prevention circuit, when a parasitic NMOS transistor is irregularly turned on, the prevention level of the ESD prevention circuit is degraded. Thus, a Ballast resistor is disposed in the ESD prevention circuit, which can prevent the parasitic NMOS transistor from being irregularly turned on.

For a large sized output circuit application, low RDS(ON) is usually required, however, a Ballast resistor can increase RDS(ON). It is assumed that cost, obtained according to the RDS(ON) and the layout size, is considered. Usually, there is no Ballast resistor or a very small Ballast resistor in a large sized output circuit. Thus, a parasitic NMOS transistor of an ESD prevention circuit can often be irregularly turned on. When the irregular turned-on condition occurs in a large sized open drain NMOS (ODMOS) transistor, the ESD problem of the output circuit becomes more serious. This is because an electrostatic discharge current has to pass through a NMOS transistor due to not having a forward base diode. Thus, impedance of the NMOS transistor is exceedingly large when the NMOS transistor is turned on, degrading ESD prevention. Additionally, when the NMOS transistor is turned on, the potential of the gate of the NMOS transistor is pulled to a low level (ground), and ESD prevention is further degraded.

### BRIEF SUMMARY OF THE INVENTION

An exemplary embodiment of an output circuit preventing damage by electrostatic discharge current comprises a voltage source, a power-clamp ESD circuit, a PMOS transistor, an NMOS transistor, and a diode. The voltage source provides a voltage. The power-clamp ESD circuit is coupled to the voltage source and directs the electrostatic current to flow in a current direction. The PMOS transistor is coupled to the voltage source. The NMOS transistor is coupled to the PMOS transistor. The diode is coupled to the voltage source. The output unit is coupled to the diode and the PMOS transistor.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is an exemplary embodiment of an output circuit.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

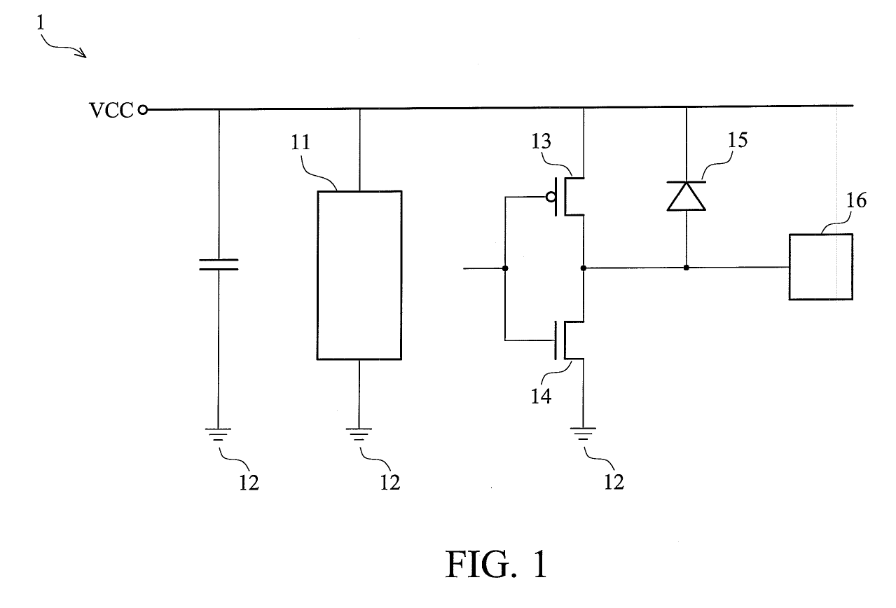

Output circuits with electrostatic discharge (ESD) prevention are provided. In an exemplary embodiment of an output circuit shown in FIG. 1, an output circuit 1 comprises a power-clamp ESD circuit 11 coupled between a voltage source VCC and a ground 12. The output circuit 1 further comprises a PMOS transistor 13, an NMOS transistor 14, a diode 15, and output unit 16. A source of the PMOS transistor 13 is coupled to the voltage source, and a drain thereof is coupled to the output unit 16. A source of the NMOS transistor 14 is coupled to the ground 12, and a drain thereof is coupled to the output unit 16. The diode 15 is coupled to the voltage source VCC, and the output unit 16 is coupled to the diode 16. The power-clamp ESD circuit 11 can direct electrostatic discharge current to flow in a current direction, from the diode 15 and sequentially to the voltage source VCC, the power-clamp circuit 11, and the ground 12. Thus, preventing the output circuit 1 from damage caused by the electrostatic current.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An output circuit preventing damage by electrostatic discharge current, comprising
a voltage source providing a voltage;
a power-clamp ESD circuit coupled between the voltage source and a ground and directing the electrostatic current to flow in a current direction,
a PMOS transistor coupled to the voltage source;
an NMOS transistor coupled to the PMOS transistor;
a diode coupled to the voltage source; and
an output unit coupled to the diode and the PMOS transistor.

2. The output circuit as claimed in claim 1,
wherein a source of the PMOS transistor is coupled to the voltage source, and a drain thereof is coupled to the output unit; and
wherein a source of the NMOS transistor is coupled to a ground, and a drain thereof is coupled to the output unit.

3. The output circuit as claimed in claim 1, wherein the current direction is from the diode and sequentially to the voltage source, the power-clamp ESD circuit, and the ground.
